(19) United States
(12) Patent Application Publication
(10) Pub. No.: US 2002/0073601 A1
(43) Pub. Date: Jun. 20, 2002

(54) Gimbal boot for fishing rod

(76) Inventor: Mark DeSorcy, Delray Beach, FL (US)

Correspondence Address: Robert M. Downey, ROBERT M. DOWNEY, P.A., Suite 350, 150 E. Palmetto Park Road, Boca Raton, FL, 33432, US

(21) Appl. No.: 10/017,092

(22) Filed: Dec. 14, 2001

Related U.S. Application Data
(60) Provisional application No. 60/256,177, filed on Dec. 15, 2000.

(51) Int. Cl. A01K 87/00

(52) U.S. Cl. 43/25

(57) ABSTRACT

A boot for covering a gimbaled butt end of a fishing rod includes a neck portion and an enlarged base with a body engaging surface structured and disposed for comfortable engagement against the body of a fisherman to thereby protect the body from pain and injury caused by the gimbaled butt end. An open end of the neck portion communicates with a hollow receptacle extending axially through the neck portion for receipt of the butt end therein. An inner wall surface surrounding the receptacle is tapered from the open end to a bottom of the receptacle and frictionally engages the butt end to hold the boot on the fishing rod. The body engaging surface is softer, smoother and larger than the butt end of the rod to thereby increase the force displacement area against the fisherman's body when fighting a fish.

### BACKGROUND OF THE INVENTION

1. Field of the Invention

The present invention relates generally to accessory equipment for fishing rods and, more particularly, to a boot or cap for removable attachment to the butt end of a fishing rod, in covering relation to a gimbal structure on the butt end, to protect a fisherman from the gimbaled end when fighting a fish in the standup position.

2. Discussion of the Related Art

Reeling in fish, particularly in big game fishing, requires a significant amount of strength to hold the fishing rod with one hand while reeling with the other hand. In order to gain leverage, many fishing rods, and particularly salt water fishing rods, are provided with gimbals on the butt end for seated engagement within a socket on a fighting chair or a rod belt.

A fighting chair is a particularly expensive apparatus which is rigidly secured to the deck of a boat, usually aft of the helm. Due to their significant cost and the space requirements for mounting, many boats are not equipped with fighting chairs. Thus, many fishermen will usually fight fish in a standing position, especially on smaller boats. And, because standup fishing is generally more challenging, many fisherman prefer standup fishing even when fighting chairs are available on a boat.

The problem with standup fishing, especially when fighting large fish, is that it is very difficult to hold the rod with one hand and operate the reel with the other hand. In an attempt to solve this problem, various body harnesses have been proposed which include a socket, similar to that found on a fighting chair, for pivotal, seated receipt of the gimbaled butt end of the fishing rod therein. While rod belts (i.e., body harnesses) are certainly more economical and versatile than fighting chairs, they due present some inconvenience to the fisherman. Specifically, rod belts are generally uncomfortable to wear and are not easily transferred from one person to another without significant manipulation and adjustments. Moreover, rod belts are somewhat expensive and, for this reason, many boat owners/fisherman do not carry more than one or two rod belts on their boat.

Typically, a fisherman will strap on a rod belt once hooking into a larger fish which is going to require a fight. However, rod belts are not always easy to strap on in a last minute haste, and particularly when trying to hold onto the fishing rod during a fight. Often, several people go scrambling to find the rod belt when someone on the boat hooks into a large fish, and, as the one person fights the fish, one or two other individuals attempt to strap the rod belt around the fisherman's waist. Larger individuals often find that the rod belt does not fit around their waist and they are forced to fight the fish with the gimbaled butt end of the rod pressed against their body. As any fisherman knows, using one's body to leverage the butt end of the rod, without any protection from the gimbaled end, can be quite painful and may result in serious bruising, laceration or other injury.

In order to overcome the problems associated with discomfort and abdominal injury caused by the gimbaled butt end of a fishing rod pressing against the body when fighting a fish in a standup position, others have proposed various cushion devices for covering the butt end. In particular, the U.S. Pat. No. 5,551,184 to Grosse, discloses a pad device for enveloping the butt end of a fishing rod in order to protect a fisherman's body when fighting a fish. The fishing rod butt pad disclosed in Grosse includes a cushion having a width at least three times the diameter of the butt end of the fishing rod and a passageway for receipt of the butt end of the fishing rod therein. A plug insert is fixed in position within the passageway to prevent the butt end of the fishing rod from passing completely through the cushion. The plug insert includes several parts which, in combination with the cushion, require considerable labor for assembly, making the fishing rod butt pad costly to manufacture. Further, the size of the cushion of the fishing rod butt pad in Grosse is considerably large, making the device somewhat cumbersome and clumsy to use. Further, the fishing rod butt pad disclosed in Grosse is not easy to store in a handy, readily available location, such as in a rod holder on a boat. Thus, when it is desirable to use the device, fisherman will inevitably be scrambling around the boat looking for the device, as one person tries to keep the fish on the line.

### BRIEF DESCRIPTION OF THE DRAWINGS

For a fuller understanding of the nature of the present invention, reference should be made to the following detailed description taken in conjunction with the accompanying drawings in which:

FIG. 1 is a side perspective view of the gimbal boot in accordance with one preferred embodiment of the present invention;

FIG. 1A is a cross-sectional view of the gimbal boot of FIG. 1;

FIG. 2 is an isolated view, in partial section, showing the gimbal boot of FIG. 1 attached to the butt end of a fishing rod;

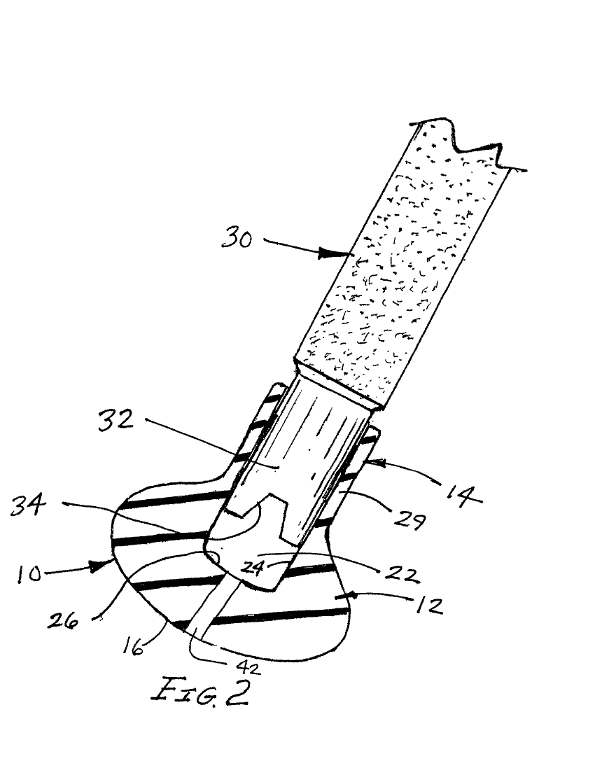

FIG. 3 is an isolated perspective view showing the gimbal boot in use on the butt end of a fishing rod and engaged against a fisherman's body when fighting a fish;

FIGS. 4-8 show side elevations of various embodiments of the gimbal boot in accordance with the present invention; and

FIG. 9 is a bottom plan view of the embodiment of FIG. 8.

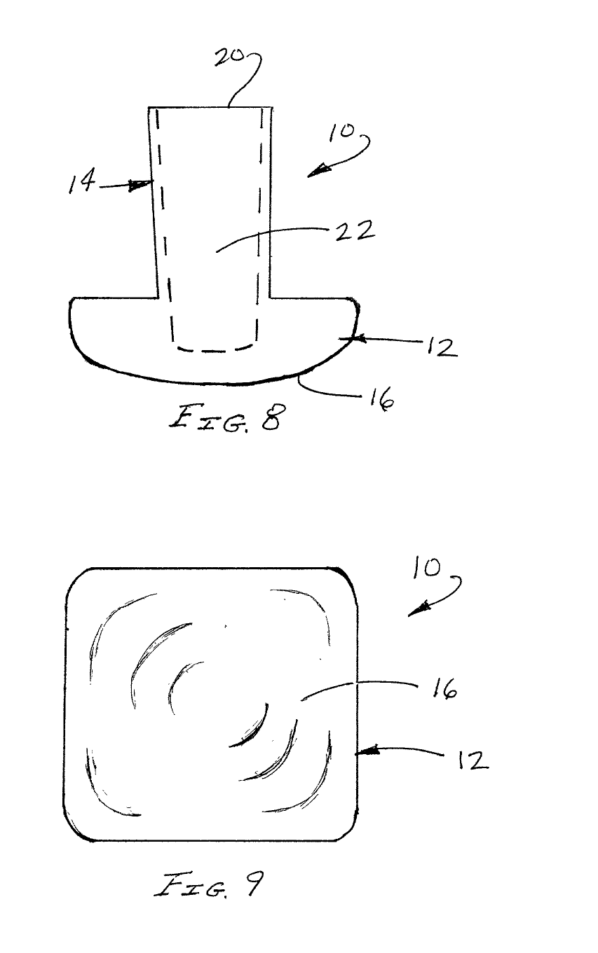

Like reference numerals refer to like parts throughout the several views of the drawings.

### DETAILED DESCRIPTION OF THE PREFERRED EMBODIMENTS

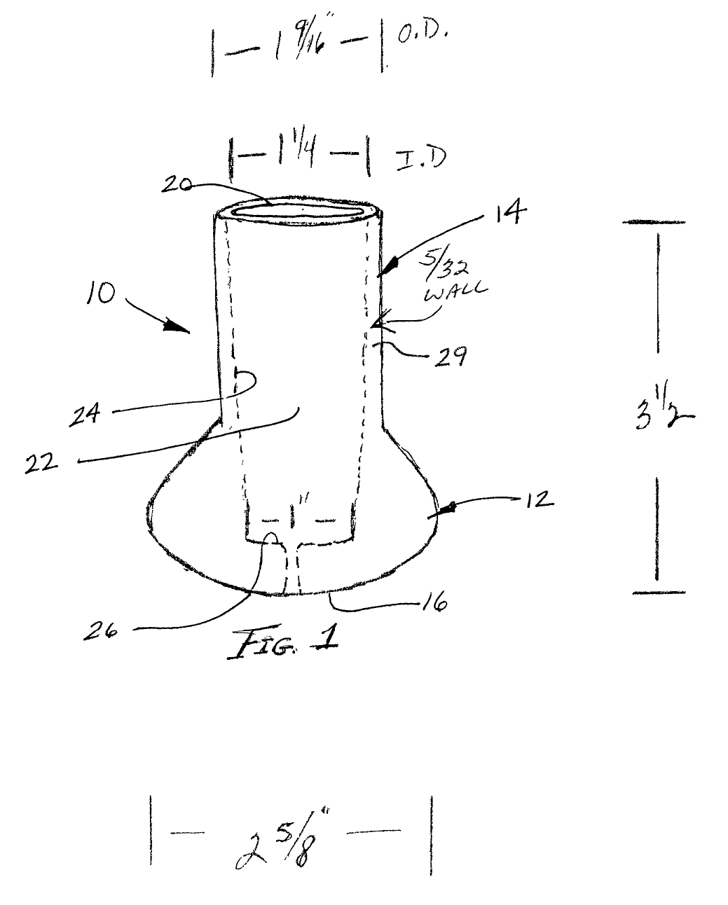

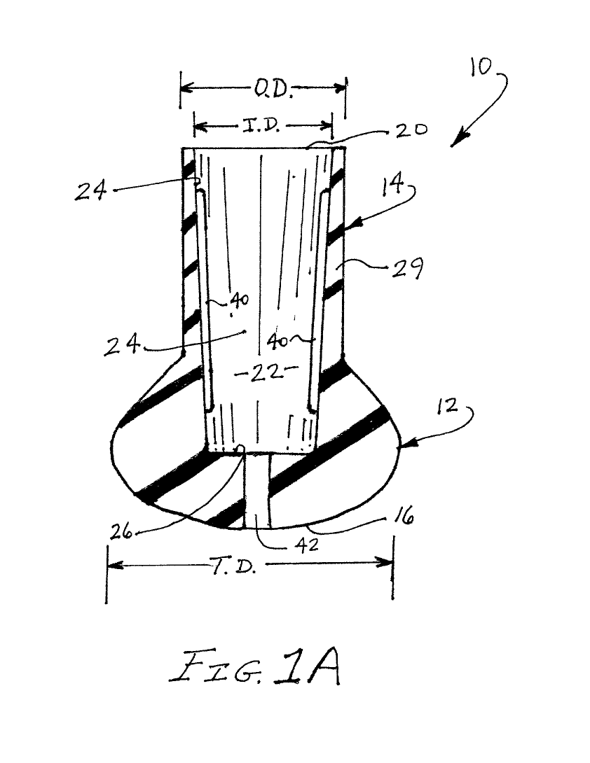

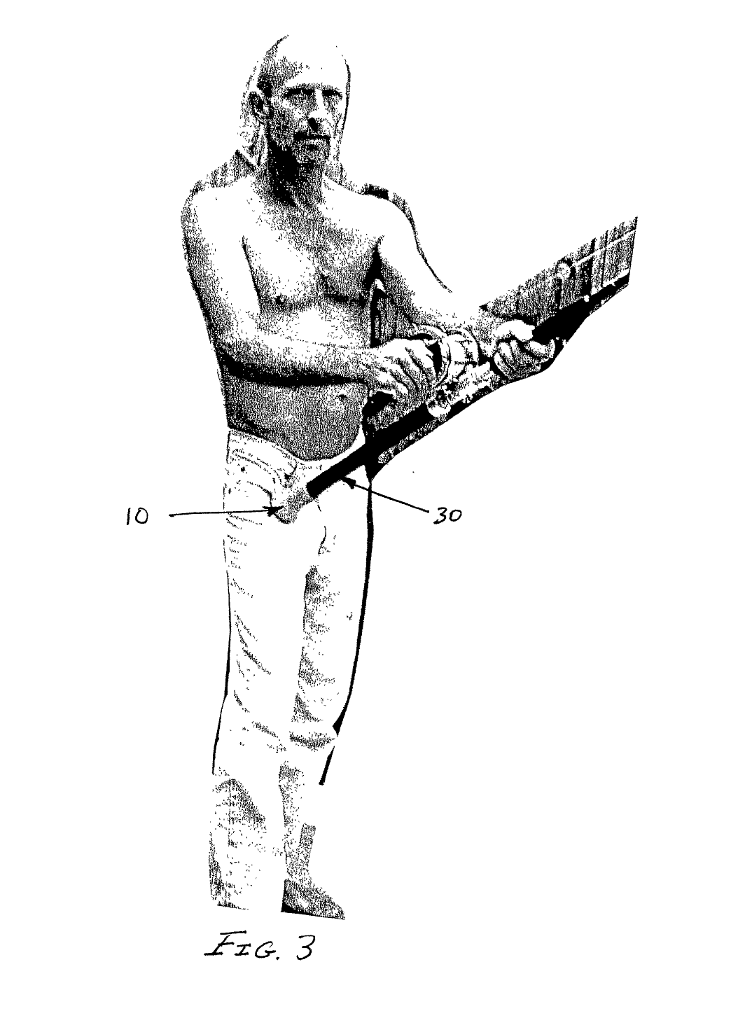

Referring initially to FIG. 1, the gimbal boot of the present invention is shown and generally indicated as 10. The gimbal boot 10 includes a base 12 and an integral neck portion 14 extending from the base. The one piece, integral gimbal boot 10 is preferably formed of a firm yet resilient material such as a rubber composition which maintains its form during use, without excessive flexing or compression. However, the resilient composition should be somewhat yielding so as to provide comfortable engagement against the body of the fisherman (see FIG. 3). Moreover, the base 12 includes a body engaging surface 16 which is contoured for engagement with the body without causing excessive pain when force is exerted on the fishing rod and against the body, such as the hip, upper thigh, pelvis or stomach.

The neck portion extends from the base and includes an open end 20 communicating with a hollow receptacle 22. The open end 20 and receptacle 22 are specifically sized and configured for receipt of the butt end 32 of the fishing rod 30 therein so that the gimbal 34 on the butt end is protectively surrounded by the base of the boot. The receptacle 22 is surrounded by an inner wall surface 24 which is tapered from the open end to a bottom 26 of the receptacle. Specifically, the diameter of the receptacle 22 gradually decreases from the open end to the bottom. In a preferred embodiment, the diameter at the open end 10 is 1-¼ inches and the diameter at the bottom 26 of the receptacle 22 is 1 inch, with the inner wall surface gradually tapering therebetween. When the butt end 32 of the fishing rod 30 is received through the open end 20 of the neck portion 14 and within the receptacle 22, the outer surface of the butt end 32 eventually engages the inner wall surface 24 of the receptacle. By applying slight downward force of the butt end 32 into the receptacle 22, a frictional engagement between the inner wall surface 24 and the outer surface of the butt end 32 of the fishing rod 30 is achieved, thereby removably attaching the boot 10 to the butt end 32.

In a preferred embodiment, the outer diameter of the neck portion 14 measures 1-9/16 inches, while the outermost diameter of the base 12 measures 2-⅝ inches. The overall height of the boot 10, measured from the body-engaging surface 16 of the base 12 to the open end 20 of the neck portion 14 measures approximately 3-½ inches. The thickness of the wall 29 of the neck portion 14 between an outer surface of the neck portion and the inner surface 24, measures approximately 5/32 inch. While the specific dimensions and configurations of the boot 10 may vary in accordance with the intended scope of the invention, it is preferable that the outermost diameter of the base 12, or transverse cross-section dimension as indicated by arrow TD in FIG. 1A, be less than three times the diameter of the open end 20 (i.e. the inner diameter I.D. and the diameter of the butt end 32 of the fishing rod 30. However, it is important that the body-engaging surface 16 be larger than the open end 20 as well as the butt end 32 of the fishing rod. Specifically, the body-engaging surface 16 is specifically structured and configured to provide an increased area for engagement against the user's body which is greater than the area of engagement of the butt end of the fishing rod, thereby distributing the force of the butt end of the fishing rod over a greater area of the body. This serves to alleviate the sharp pain of the force exerted by the butt end of the fishing rod against the body, while providing a more comfortable engagement with a smooth, slightly rounded contour which more gently engages the body and rolls against the user's body as the angle of the tip of the fishing rod is changed when fighting a fish. Moreover, it is clear from the drawings that the base portion is larger than the neck portion. Specifically, the transverse cross-sectional dimension T.D. is preferably greater than two times the inner diameter I.D. of the hollow receptacle at the open end 20. Further, the outer periphery of the base portion, measured about the widest point defined by the greatest transverse dimension T.D. is significantly larger than the outer periphery or circumference of the neck portion as determined by the outer diameter O.D.

As seen in FIG. 1A, the inner receptacle 22 may be provided with two or more longitudinally extending ribs 40 integrally formed with the one-piece gimbal boot 10 as part of the inner wall structure. The longitudinal ribs 40 are specifically structured and disposed for frictional engagement with the butt end of the fishing rod and are designed to slightly compress as the butt end of the fishing rod is forced down through the receptacle 22. The longitudinal ribs 40 help to hold the gimbal boot 10 on the butt end of the fishing rod while preventing the gimbal boot 10 from becoming stuck to the butt end. To further prevent the gimbal boot 10 from becoming stuck on the butt end of the fishing rod, a vent hole 42 is provided through the base portion and in airflow communication with the hollow interior receptacle 22. The vent hole 42 allows the air pressure within the receptacle 22 to remain equalized with atmospheric pressure, and helps to promote forced removal of the gimbal boot 10 from the butt end of the fishing rod without becoming stuck due to excess friction and/or vacuum pressure within the hollow interior receptacle.

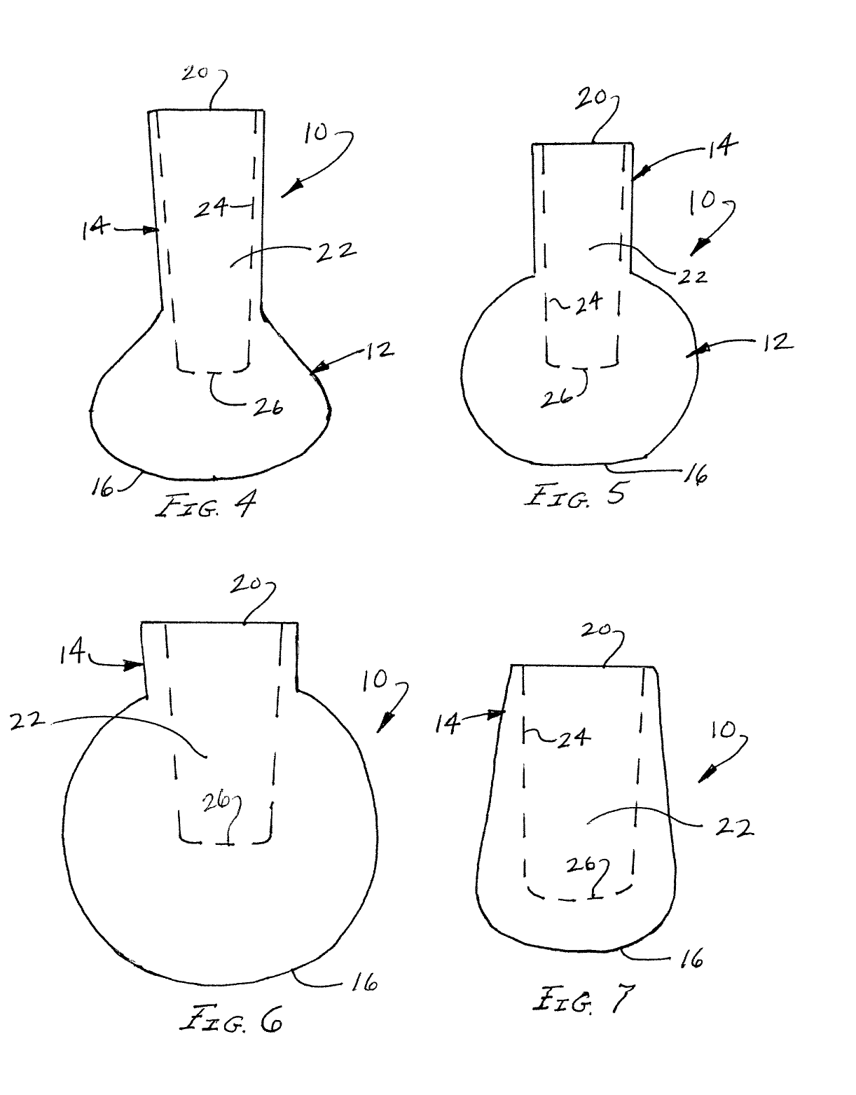

The neck portion 14 is advantageously sized and configured for receipt within a conventional rod holder on a boat, such as that found formed in the gunnel in a fishing boat. Thus, the boot 10 can be placed within an empty rod holder, in an inverted position, so that it is readily visible and available to a fisherman when needed without having to scramble around the boat and search for the boot when a fish is on the line. When fishing, a number of boots 10 can be placed in rod holders around the boat so that they are conveniently available to one or more people fishing on the boat. Further, the boot 10 can be manufactured in various colors, such as bright neon colors, so that the boot is easily visible when needed. It is also preferable that the composition used in the manufacture of the boot 10 be of a sufficient buoyancy to allow the boot to float so that it can be easily retrieved if accidentally dropped in the water. FIGS. 1 and 4-8 illustrate various configurations of the boot 10, and particularly the base 12, in accordance with the present invention. It should be noted that the configurations of the boot 10 shown in the drawings are not to be interpreted in a limiting sense, but are provided as examples to demonstrate the variation in configuration of the boot in accordance with the intended scope of the invention.

While the present invention has been shown and described in accordance with various embodiments thereof, the instant disclosure is not intended to be interpreted to limit the scope of the invention. Moreover, it is noted that departures from the instant disclosure are contemplated within the spirit and scope of the present invention.

What is claimed is:

1. A device for covering a gimbaled butt end of a fishing rod, comprising:
a one-piece integrally formed body comprising:
a base portion having a body-engaging surface structured and disposed for comfortable engagement against the body of a user of the fishing rod;
a neck portion extending from said base portion and having an open end communicating with a hollow receptacle extending axially through said neck portion and surrounded by an inner wall surface of said neck portion, said inner wall surface extending from said open end to a bottom of said receptacle;
said inner wall surface tapering from said open end to said bottom so that a diameter of said receptacle at said open end is greater than a diameter of said receptacle at said bottom, and said inner wall surface being structured and disposed for frictional engagement with the butt end of the fishing rod to releasably hold the body on the butt end of the fishing rod; and
said body-engaging surface on said base portion being larger than said open end of said neck portion.

2. The device as recited in claim 1 wherein said base portion includes a transverse cross-sectional dimension which is greater than two times the diameter of said hollow receptacle at said open end.

3. The device as recited in claim 2 wherein an outer periphery of said base portion surrounding said body-engaging surface is larger than an outer periphery of said neck portion.

4. The device as recited in claim 3 wherein said body is formed of a firm rubber composition.

5. The device as recited in claim 3 wherein said inner wall surface includes at least two longitudinally extending ribs structured and disposed for frictional engagement with the butt end of the fishing rod.

6. The device as recited in claim 3 wherein said base portion includes at least one air passage formed therethrough and in airflow communication with said hollow receptacle to promote forced removal of the butt end of the fishing rod from frictional engagement within the hollow receptacle.

7. The device as recited in claim 5 wherein said body is formed of a firm yet resilient rubber composition.

8. The device as recited in claim 6 wherein said body is formed of a firm yet resilient rubber composition.

9. A device for covering a gimbaled butt end of a fishing rod, comprising:
a one-piece integrally formed body comprising:
a base portion having a body-engaging surface structured and disposed for comfortable engagement against the body of a user of the fishing rod;
a neck portion extending from said base portion and having an open end communicating with a hollow receptacle extending axially through said neck portion and surrounded by an inner wall surface of said neck portion, said inner wall surface extending from said open end to a bottom of said receptacle, and said inner wall surface being structured and disposed for frictional engagement with the butt end of the fishing rod to releasably hold the body on the butt end of the fishing rod; and
said body-engaging surface on said base portion being larger than said open of said neck portion.

10. The device as recited in claim 9 wherein said base portion includes a transverse cross-sectional dimension which is greater than two times the diameter of said hollow receptacle at said open end.

11. The device as recited in claim 10 wherein an outer periphery of said base portion surrounding said body-engaging surface is larger than an outer periphery of said neck portion.

12. The device as recited in claim 11 wherein said body is formed of a firm rubber composition.

13. The device as recited in claim 12 wherein said inner wall surface includes at least two longitudinally extending ribs structured and disposed for frictional engagement with the butt end of the fishing rod.

14. The device as recited in claim 12 wherein said base portion includes at least one air passage formed therethrough and in airflow communication with said hollow receptacle to promote forced removal of the butt end of the fishing rod from frictional engagement within the hollow receptacle.

15. The device as recited in claim 13 wherein said body is formed of a firm yet resilient rubber composition.

16. The device as recited in claim 14 wherein said body is formed of a firm yet resilient rubber composition.
